(19) United States
(12) Patent Application Publication
(10) Pub. No.: US 2010/0169125 A1
(43) Pub. Date: Jul. 1, 2010

(54) INSURANCE POLICY MANAGEMENT IN A VIRTUAL UNIVERSE

(75) Inventors: Christopher J. Dawson, Arlington, VA (US); Vincenzo V. Diluoffo, Sandy Hook, CT (US); Michael D. Kendzierski, New York, NY (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/344,800

(22) Filed: Dec. 29, 2008

(51) Int. Cl. G06Q 40/00; G06Q 50/00

(52) U.S. Cl. 705/4

(57) ABSTRACT

An invention that manages insurance policies in a virtual universe is provided. In one embodiment, there is an insurance management tool including a rating component configured to assign a rating to an avatar based on a past behavior of the avatar. The insurance management tool further includes an insurance component configured to enable the use of an insurance policy to manage a behavior of the avatar in the virtual universe based on the rating of the avatar.

### CROSS-REFERENCE TO RELATED APPLICATION

This application is related in some aspects to the commonly owned and co-pending application entitled “System and Method to Associate a Behavior Rating System to Avatars in a Virtual World,” filed Sep. 23, 2008, and which is assigned docket number AUS920080556 and U.S. patent application Ser. No. 12/236,321, the entire contents of which is herein incorporated by reference.

### FIELD OF THE INVENTION

This invention relates generally to virtual universes and more specifically to the management of avatar behavior in a virtual universe.

### BACKGROUND OF THE INVENTION

Virtual universes or virtual worlds are computer-based simulated environments intended for its users or residents to inhabit and interact via avatars, which are personas or representations of the users of the virtual universes. These types of virtual universes are now most common in massively multiplayer online games such as Second Life®, which is a trademark of Linden Research Inc. in the United States. Avatars in these types of virtual universes, which can number well over a million, have a wide range of business and social experiences.

Virtual universes may have a number of different regions or locations within the virtual universe for avatars to inhabit and navigate. Each of these regions may include policies or regulations that are put in place to govern appropriate behavior in the region. Such region may involve children or avatars that belong to a community restricted by age or a certain level of appropriate content. Unfortunately, not all avatars behave in a manner that is appropriate for the virtual universe, or a certain location within the virtual universe.

### SUMMARY OF THE INVENTION

In one embodiment, there is a method for managing avatar behavior in a virtual universe. In this embodiment, the method comprises: assigning a rating to an avatar based on a past behavior of the avatar; and enabling the use of an insurance policy to manage a behavior of the avatar in the virtual universe based on the rating of the avatar.

In a second embodiment, there is a computer system for managing avatar behavior in a virtual universe. In this embodiment, the system comprises at least one processing unit and memory operably associated with the at least one processing unit. An insurance management tool is storable in memory and executable by the at least one processing unit. The insurance management tool comprises a rating component configured to assign a rating to an avatar based on a past behavior of the avatar; and an insurance component configured to enable the use of an insurance policy to manage a behavior of the avatar in the virtual universe based on the rating of the avatar.

In a third embodiment, there is a computer-readable medium storing computer instructions, which when executed, enables a computer system to manage avatar behavior in a virtual universe, the computer instructions comprise: assigning a rating to an avatar based on a past behavior of the avatar; and enabling the use of an insurance policy to manage a behavior of the avatar in the virtual universe based on the rating of the avatar.

In a fourth embodiment, there is a method for deploying an insurance management tool for use in a computer system that manages avatar behavior in a virtual universe. In this embodiment, a computer infrastructure is provided and is operable to: assign a rating to an avatar based on a past behavior of the avatar; and enable the use of an insurance policy to manage a behavior of the avatar in the virtual universe based on the rating of the avatar.

### BRIEF DESCRIPTION OF THE DRAWINGS

FIG. 1 shows a high-level schematic diagram showing a networking environment for providing a virtual universe according to one embodiment of this invention;

FIG. 2 shows a more detailed view of a virtual region shown in the virtual universe of FIG. 1;

FIG. 3 shows a more detailed view of the virtual universe client shown in FIG. 1;

FIG. 4 shows a more detailed view of some of the functionalities provided by the server array shown in FIG. 1;

FIG. 5 shows an insurance management tool according to one embodiment of this invention that operates in the environment shown in FIG. 1;

FIG. 6 shows an access notification according to one embodiment of this invention that operates in the environment shown in FIG. 1;

FIG. 7 shows a schematic of an exemplary computing environment in which elements of the networking environment shown in FIG. 1 may operate; and

FIG. 8 shows a flow diagram of a method for managing avatar behavior in a virtual universe according to one embodiment of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to managing avatar behavior in a virtual universe using an insurance policy, such that users and their avatars are held accountable for their behavior. In these embodiments, the insurance policy provides an incentive to users to adhere to the rules of the virtual universe or a region within the virtual universe. To accomplish this, the present invention includes an insurance management tool comprising a rating component configured to assign a rating to an avatar based on a past behavior of the avatar. The insurance management tool further comprises an insurance component configured to enable the use of an insurance policy to manage a behavior of the avatar in the virtual universe based on the rating of the avatar. The insurance policy mitigates risk associated with allowing an avatar with a low rating to enter restricted locations, or perform a specific set of activities in the virtual universe.

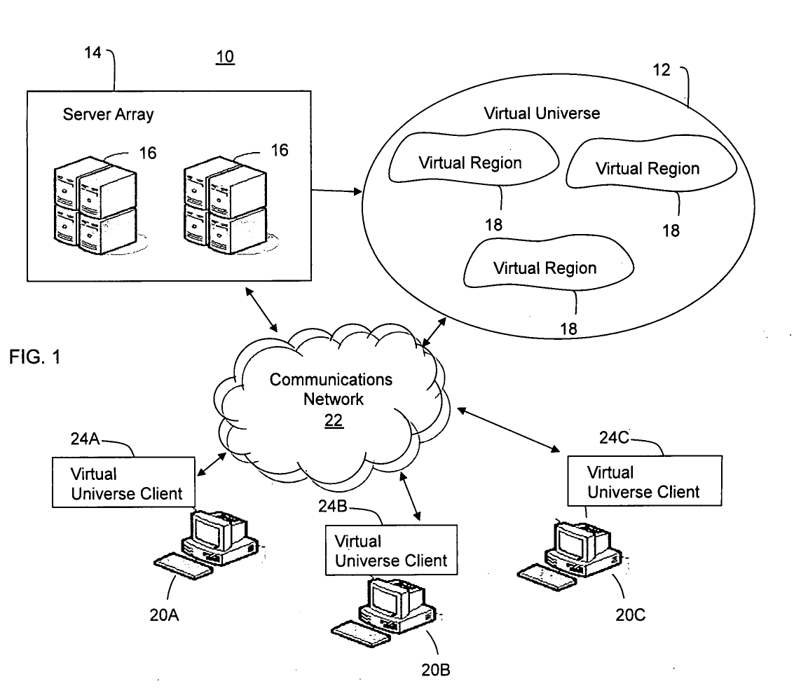

FIG. 1 shows a high-level schematic diagram showing a networking environment 10 for providing a virtual universe 12 according to one embodiment of this invention in which a service for managing avatar behavior can be utilized. As shown in FIG. 1, the networking environment 10 comprises a server array or grid 14 comprising a plurality of servers 16 each responsible for managing a portion of virtual real estate within virtual universe 12. A virtual universe provided by a multiplayer online game, for example, can employ thousands of servers to manage all of the virtual real estate. The virtual content of the virtual real estate that is managed by each of servers 16 within server array 14 shows up in virtual universe 12 as a virtual region 18 made up of objects, textures and scripts. Like the real-world, each virtual region 18 within virtual universe 12 comprises a landscape having objects, such as buildings, stores, clubs, sporting arenas, parks, beaches, cities and towns all created by residents of the universe that are represented by avatars. These examples of objects and virtual content are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe, or even only one region in a small virtual universe. FIG. 1 also shows that users operating computers 20A-20C (hereinafter referred generally as 20) interact with virtual universe 12 through a communication network 22 via virtual universe clients 24A-24C (hereinafter referred generally as 24) that reside in the computers 20, respectively. Below are further details of virtual universe 12, server array 14, and virtual universe client 24.

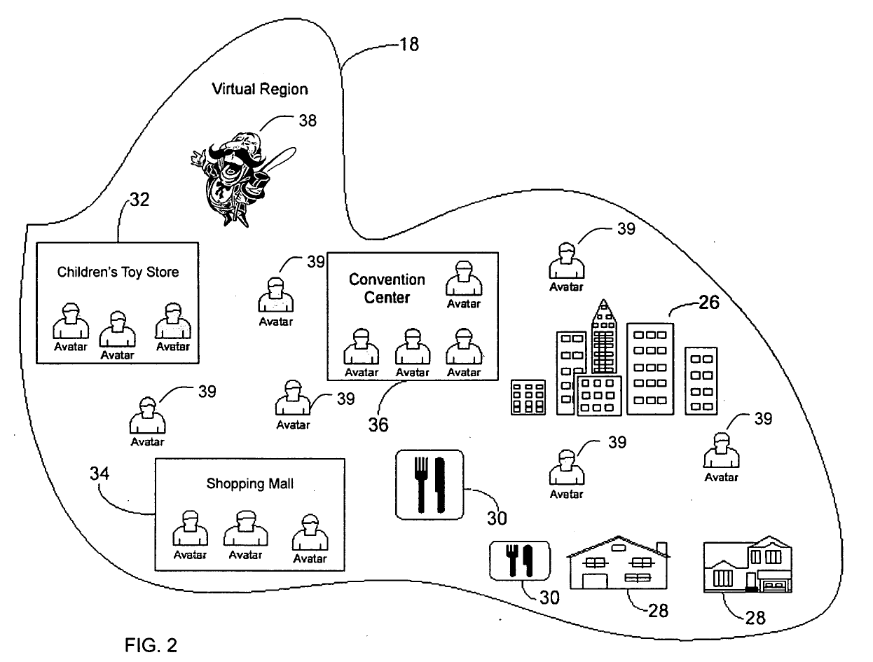

FIG. 2 shows a more detailed view of what one virtual region 18 shown in virtual universe 12 of FIG. 1 may comprise. As an example, virtual region 18 shown in FIG. 2 comprises objects, including: a downtown office center 26, homes 28, restaurants 30, a children's toy store 32 and a shopping mall 34 for shopping, and a convention center 36 for meetings and various conventions. Residents or avatars 38, which as mentioned above, are personas or representations of the users of the virtual universe, roam all about the virtual region by walking, driving, flying or even by teleportation or transportation, which is essentially moving through space from one point to another, more or less instantaneously. A number of other avatars 39 represent other avatars/users within the virtual universe who may have contact with or past interactions with avatar 38. Although the invention is described in the context of an exemplary avatar 38 and other avatars 39 for the sake of clarity, those skilled in the art will recognize that the methods described herein for managing avatar behavior apply broadly to avatar 38 and other avatars 39. Further, virtual universe 12 is not limited to the embodiment shown, and can have any number of avatars and objects that can be found in real-life as well as the virtual world.

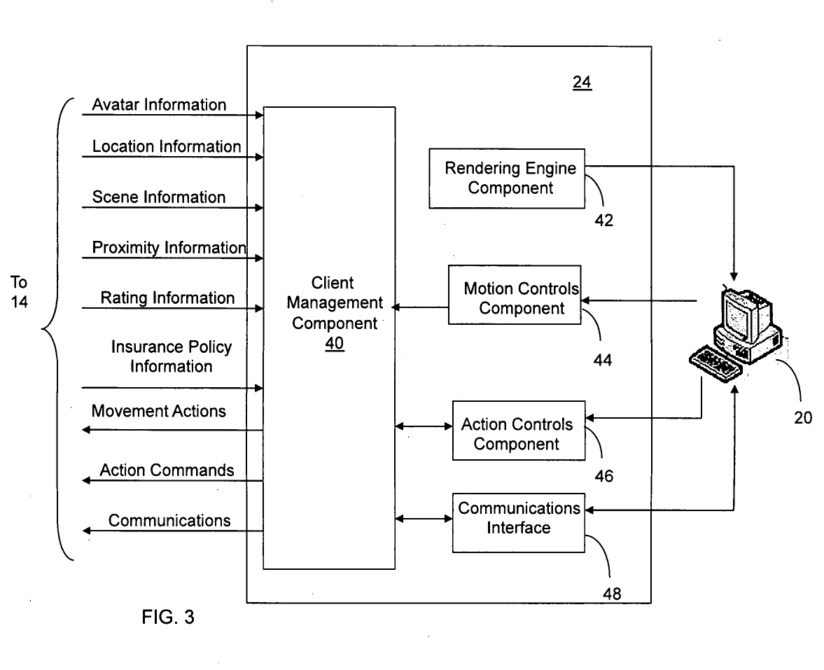

FIG. 3 shows a more detailed view of virtual universe client 24 shown in FIG. 1. Virtual universe client 24, which enables users to interact with virtual universe 12, comprises a client management component 40, which manages actions, movements and communications made by a user through computer 20, and information received from the virtual universe through server array 14. A rendering engine component 42 enables the user of computer 20 to visualize his or her avatar within the surroundings of the particular region of virtual universe 12 that the avatar is presently located.

A motion controls component 44 enables the user to make movements through the virtual universe. In one embodiment, movements through the virtual universe can include, for example, gestures, postures, walking, running, driving, flying, etc. An action controls component 46 enables the user to perform actions in the virtual universe, such as buying items for his or her avatar or even for their real-life selves, building homes, planting gardens, etc., as well as changing the appearance of their avatar. These actions are only illustrative of some possible actions that a user can perform in the virtual universe and are not limiting. A communications interface 48 enables a user to communicate with other users of virtual universe 12 through modalities such as chatting, instant messaging, gesturing, talking and electronic mail (e-mail).

FIG. 3 shows the various types of information received by client management component 40 from the virtual universe through server array 14. In particular, client management component 40 receives location information about the area that the user's avatar is near (e.g., what region or land he or she is in) as well as scene information, including information about objects within a given region or area of the virtual universe. Client management component 40 also receives proximity information, which contains information on what the user's avatar is near. FIG. 3 also shows the movement actions and action commands that are generated by the user and sent to the server array via client management component 40, as well as the communications that can be sent to the users of other avatars within the virtual universe.

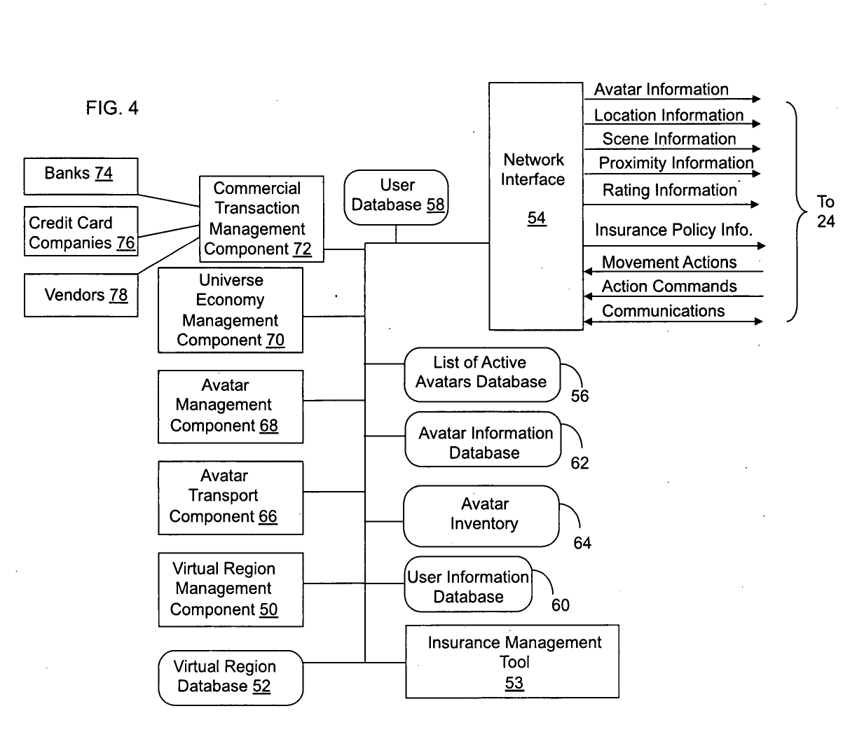

FIG. 4 shows a more detailed view of some of the functionalities provided by server array 14 shown in FIG. 1. In particular, FIG. 4 shows a virtual region management component 50 that manages a portion of virtual universe 12, such as virtual region 18 (FIG. 2). Virtual region management component 50 manages what happens in a particular region, such as the type of landscape in that region, the number of homes, commercial zones, boutiques, streets, parks, restaurants, etc. For example, virtual region management component 50 would allow the owner of a particular region or establishment within the region to specify requirements for entering or remaining within the region that could potentially affect whether or not an avatar needs an insurance policy. Those skilled in the art will recognize that virtual region management component 50 can manage many other facets within the virtual region.

FIG. 4 also shows an insurance management tool 53 for managing avatar behavior in the virtual universe, as described herein. In this embodiment, insurance management tool 53 resides on the same side as server array 14. However, it can be appreciated that in other embodiments, insurance management tool 53 may reside on virtual universe client 24, or reside on separate computers in direct communication with the virtual universe servers 16 and virtual universe clients 24.

As shown in FIG. 4, there are several different databases for storing information. In particular, a virtual region database 52 stores information on all of the specifics in virtual region 18 that virtual region management component 50 is managing. Virtual region database 52 contains metadata information about the objects, texts and scripts associated with the virtual content in virtual region 18. List of active avatars database 56 contains a list of all the avatars that are online in virtual universe 12. Databases 58 and 60 contain information on the actual human users of virtual universe 12. In one embodiment, user database 58 contains general information on the users such as names, addresses, interests, ages, etc., while user information database 60 contains more sensitive information on the users such as email addresses, and billing information (e.g., credit card information) for taking part in transactions, including the purchase of an insurance policy.

Databases 62 and 64 contain information on the avatars of the users that reside in virtual universe 12. Specifically, avatar information database 62 contains information such as all of the avatars that a user may have, and the profile of each avatar, which includes information about a behavior rating assigned to each avatar. Avatar inventory 64 is a database that contains an inventory listing of the assets within the personal inventory of each avatar, such as hairpieces, weapons, jewelry, houses, cars, sporting equipment, appearance, attire, etc. Avatar inventory 64 also contains any insurance policies that are owned by each avatar. Those skilled in the art will recognize that databases 56-64 may contain additional information if desired. Further, although the above information is shown in FIG. 4 as being stored in separate databases, those skilled in the art will recognize that other database configurations and other means of storing information can be utilized.

FIG. 4 shows a network interface 54 that enables server array 14 to interact with virtual universe client 24 residing on computer 20. In particular, the network interface 54 communicates avatar, location, scene, proximity, rating, and insurance policy information to the user through virtual universe client 24. Network interface 54 receives movement and action commands, as well as communications from the user via virtual universe client 24.

An avatar transport component 66 enables users to transport, which as mentioned above, allows avatars to transport through space from one point to another point, more or less instantaneously. An avatar management component 68 keeps track of what avatars are doing while in the virtual universe. For example, avatar management component 68 can track where each avatar is presently located in the virtual universe, what activities the avatars are performing or may perform next, and whether those activities are appropriate for that location. An illustrative but non-exhaustive list of activities can include shopping, eating, talking, recreating, etc.

Because a typical virtual universe has a vibrant economy, server array 14 has functionalities that are configured to manage the economy. In particular, a universe economy management component 70 manages transactions that occur within the virtual universe. In one embodiment, virtual universe 12 has its own currency that users pay for with real-life money. The users can then take part in commercial transactions for their avatars through universe economy management component 70. For example, an avatar might want to pay for a service that provides insurance polices within the virtual universe. The insurance policy may be provided by an owner of a virtual universe or a particular region within the virtual universe, or by a third-party provider. The avatar can purchase the insurance policy using the virtual universe currency. In order to fulfill this type of transaction and others similarly related, commercial transaction management component 72 interacts with banks 74, credit card companies 76 and vendors 78.

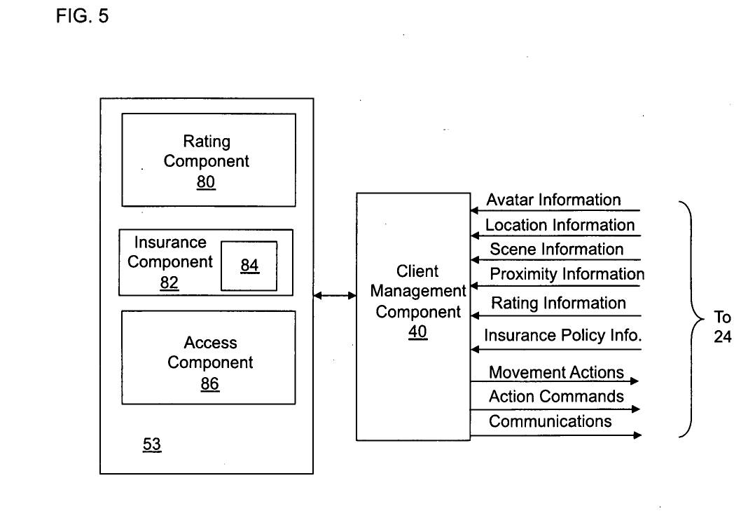

Referring now to FIG. 5, insurance management tool 53 of the present invention will be described in further detail. Specifically, insurance management tool 53 provides the capability to manage avatar behavior in the virtual universe using an insurance policy 84, which insures against a violation of a set of behavioral requirements of avatars in the virtual universe or a location within the virtual universe (e.g., a particular region, store, community, etc.). Insurance policy 84 provides a financial incentive to users/avatars to conform to the set of behavioral requirements established by the operator of the virtual universe or a particular location in the virtual universe.

To accomplish this, insurance management tool 53 comprises a rating component 80 configured to assign a rating to each avatar within the virtual universe based on a past behavior of each of the avatars. In general, avatars that have behaved according to the behavioral requirements are given a positive (i.e., high) rating by rating component 80. Avatars that have violated the behavioral requirements are given a negative (i.e., low) rating by rating component 80. This rating may be determined in a number of ways, including by input received from other avatars within the virtual universe, or established automatically by the virtual universe based on the actions, movements and language of the avatar. For example, one location within the virtual universe may have a requirement that appropriate language be used at all times. The location constantly monitors conversations (e.g., chat) between each avatar within the location. Any profane, vulgar, or sexually explicit language used by an avatar in this location will automatically violate the language requirement and have a negative affect on the avatar's rating. A decreased rating may cause the avatar to be removed from the location, as well as require the subsequent use of an insurance policy as a guarantee against such objectionable language in the future, as will be further described below. It will be appreciated that the methods employed by rating component 80 described herein are exemplary and non-limiting. Other means of rating avatars and their behavior within the virtual universe may be used, including those described in commonly owned and co-pending application entitled “System and Method to Associate a Behavior Rating System to Avatars in a Virtual World,” filed Sep. 23, 2008, and which is assigned docket number AUS920080556 and U.S. patent application Ser. No. 12/236,321, the entire contents of which is herein incorporated by reference.

Based on the rating assigned to the avatar by rating component 80, an insurance policy may be used for managing the behavior of the avatar. As shown in FIG. 5, insurance management tool 53 comprises an insurance component 82 configured to enable the use of insurance policy 84 to manage the behavior of avatars in the virtual universe based on the rating of each avatar. Insurance policy 84 is an agreement between an avatar and an insurance provider (e.g., a third-party insurance provider, or the operator/provider of the virtual universe), in which the insurance provider agrees to “cover” the avatar, i.e., provide restitution to the provider of the virtual universe in the event that the avatar violates one of the behavioral requirements of the virtual universe. In exchange for this coverage, the user of the avatar agrees to pay the insurance provider, e.g., in the form of a lump-sum payment, or in a series of premium payments. In another embodiment, avatars may offer some form of collateral to the insurance provider in lieu of, or in addition to, a monetary payment. For example, an avatar may transfer assets from the avatar's personal inventory to an escrow account accessible by the insurance provider. Should the avatar violate one of the behavioral requirements of the virtual universe, the assets will be removed from the escrow account and permanently forfeited by the avatar.

As described above, insurance policy 84 can be purchased using assets and/or virtual universe currency that users pay for with real-life money. If an avatar violates at least one of the set of behavioral requirements in the virtual universe, insurance component 82 is configured to forfeit at least a portion of the money and/or asset(s) associated with insurance policy 84. Depending on the seriousness of the violation committed by the avatar, the entire monetary value on the policy may be forfeited by the avatar. Forfeiture may be accompanied by expulsion from the location in the virtual universe where the violation was committed, or even from the virtual universe as a whole. An access component 86 is configured to remove the avatar from the restricted location if the avatar violates at least one of the behavioral requirements in the virtual universe. Further, rating component 80 may adjust the rating of the avatar if the avatar violates at least one of the behavioral requirements of the virtual universe. Each violation and/or removal from a location in the virtual universe may negatively affect the rating of the avatar, thus requiring the purchase of a new insurance policy, or increased premium payments to maintain an existing policy.

In one embodiment, access component 86 is configured to require the use of an insurance policy by the avatar as a prerequisite for access to a restricted location of the virtual universe based on the rating of the avatar. Avatars with a low rating may be required to have an insurance policy prior to accessing restricted locations within the virtual universe, or prior to performing a specific action within the virtual universe. For example, an avatar with a past history of using racially offensive language in the virtual universe may be required to have an insurance policy before entering a location in the virtual universe frequented by users belonging to a specific racial and/or ethnic group. Or, in another example, an avatar with a past history of using sexually explicit language may be required to carry an insurance policy before initiating a conversation (e.g., chat, e-mail, etc.) with a younger user who may be traversing the virtual universe in a non-restricted area. However, it can be appreciated that some avatars may require no insurance policy at all. For example, an insurance policy may not be necessary for an avatar with an excellent (i.e., very high) rating based on the avatar's past history of following all required rules and regulations in the virtual universe.

In another embodiment, each avatar in the virtual universe may be required to carry an insurance policy to maintain their membership with the virtual universe. For example, each avatar may be required to carry at least a “basic” insurance policy at all times. The basic insurance policy allows the avatar to traverse the more common areas of the virtual universe, but may restrict access to more sensitive locations. Users may be able to upgrade this basic insurance policy by adding features or options that allow the avatar increased freedom within the virtual universe. For example, avatars may be given an option to purchase a “deluxe” insurance policy, which gives the avatar unlimited opportunity and freedom within the virtual universe for a greater period of time. The deluxe insurance policy typically costs more than the basic insurance policy and carries with it stricter behavioral requirements for the avatar. Operators of restricted locations in the virtual universe may agree to accept all avatars carrying the deluxe insurance policy, as these avatars are more likely to abide by all behavioral requirements of the restricted location. Further, it will be appreciated that the cost of purchasing both the basic insurance policy and the deluxe insurance policy varies based on the rating of the avatar.

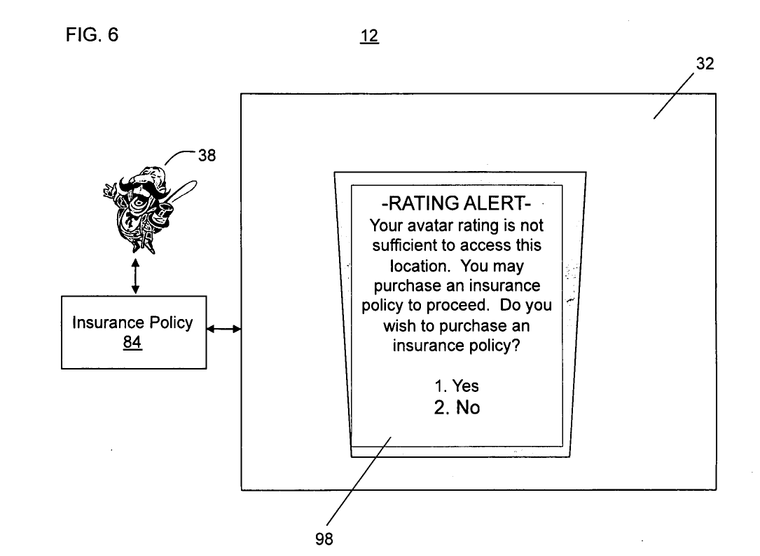

Referring now to FIGS. 2 and 6, consider the following example, in which avatar 38 wishes to enter a restricted location within virtual region 18, such as children's toy store 32 depicted in FIG. 2. Children's toy store 32 may be restricted by its operator to only accept avatars with a rating of “good” or above. In this example, avatar 38 may only have a “fair” rating based on past interactions with other avatars 39 in virtual region 18. Based on this rating, avatar 38 is denied immediate access to children's toy store 32. Instead, avatar 38 is presented with an access notification 98, which may take on many forms, including the pop-up sign shown in FIG. 6. In one embodiment, access notification 98 is generated as a link to a third-party insurance provider. Avatar 38 may teleport, relocate, or otherwise interact with the insurance provider to purchase an insurance policy.

Next, the user of avatar 38 acknowledges the behavioral requirements to access children's toy store 32 and determines that he/she would like to purchase insurance policy 84 for a predetermined value. Insurance policy 84 is purchased and placed into the personal inventory of avatar 38. When avatar 38 attempts to enter children's toy store 32 again, children's toy store 32 checks the personal inventory of avatar 38 to ensure that a valid insurance policy exists. If the insurance policy is found, avatar 38 is allowed to remain within toy store 32.

Once avatar 38 enters children's toy store 32, a notification (e.g., a warning message) is sent to avatar 38 stating that avatar 38 is entering a location where insurance policy 84 is being used. This notification (not shown) may include the behavioral requirements expected of avatar 38 while in children's toy store 32. The behavior of avatar 38 is constantly monitored, and as long as its behavior does not violate a prohibited action, avatar 38 is allowed to remain in children's toy store 32 for the time duration stated on insurance policy 84. However, if avatar 38 performs a prohibited action(s), a warning or series of warnings may be given to avatar 38. If avatar 38 continues to violate the behavioral requirements of children's toy store 32 as agreed upon in the insurance policy, the policy is voided, avatar 38 is removed from children's toy store 32, and the rating of avatar 38 is decreased. Any monetary funds and/or assets are forfeited and may be divided between virtual universe 12 and children's toy store 32 according to a predetermined agreement. If avatar 38 wishes to subsequently re-enter children's toy store 32, avatar 38 is required to again purchase insurance policy 84.

In another embodiment of this invention, insurance management tool 53 is used as a service to charge fees for managing the behavior of avatars in the virtual universe using insurance policies. In this embodiment, the provider of the virtual universe or a third party service provider could offer the insurance policy as a service by performing the functionalities described herein on a subscription and/or fee basis. In this case, the provider of the virtual universe or the third party service provider can create, deploy, maintain, support, etc., insurance management tool 53 that performs the processes described in the invention. In return, the virtual universe or the third party service provider can receive payment from the virtual universe residents via universe economy management component 70 and commercial transaction management component 72 (FIG. 4).

In still another embodiment, the methodologies disclosed herein can be used within a computer system to manage avatar behavior in the virtual universe. In this case, insurance management tool 53 can be provided, and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

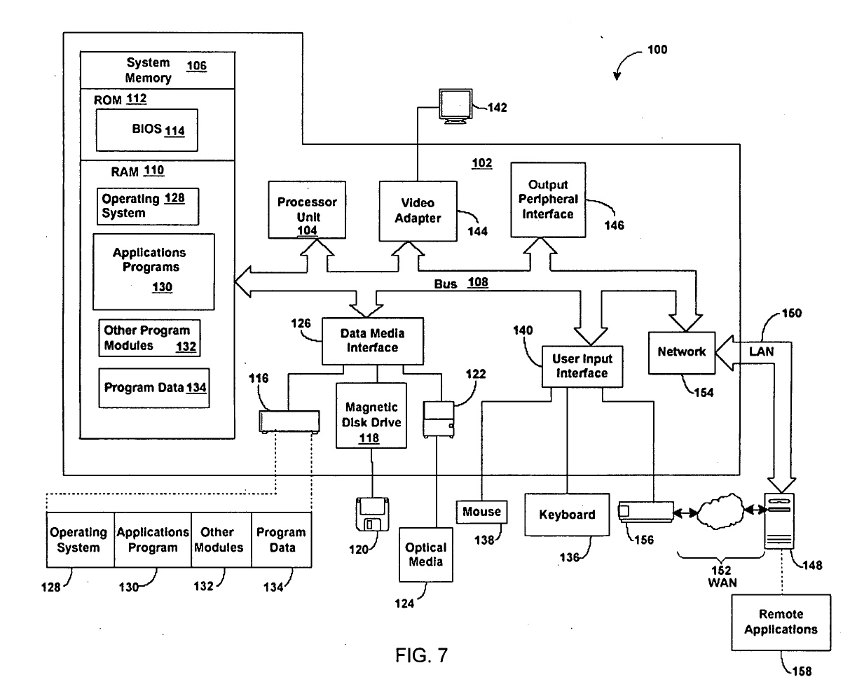

FIG. 7 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should computing environment 100 be interpreted as having any dependency or requirement relating to any one or combination of components illustrated in FIG. 7.

Computing environment 100 comprises a computer 102, which is operational with numerous other general purpose or special purpose computing system environments or configurations. Examples of well known computing systems, environments, and/or configurations that may be suitable for use with computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Computer 102 may be described in the general context of computer-executable instructions, such as program modules, being executed by a computer. Generally, program modules include routines, programs, objects, components, logic, data structures, and so on that perform particular tasks or implements particular abstract data types. Computer 102 may be practiced in distributed computing environments where tasks are performed by remote processing devices that are linked through a communications network. In a distributed computing environment, program modules may be located in both local and remote computer storage media including memory storage devices.

As shown in FIG. 7, computer 102 in computing environment 100 is shown in the form of a general-purpose computing device. The components of computer 102 may include, but are not limited to, one or more processors or processing units 104, a system memory 106, and a bus 108 that couples various system components including system memory 106 to processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer 102 typically includes a variety of computer readable media. Such media may be any available media that is accessible by computer 102, and it includes both volatile and non-volatile media, removable and non-removable media.

In FIG. 7, system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 7 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. Hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130 other program modules 132, and program data 134 or some combination thereof, may include an implementation of the networking environment 10 of FIG. 1 including server array 14 and virtual universe client 24. In one embodiment, the one or more application programs 130 include components of insurance management tool 53 such as rating component 80, insurance component 82, insurance policy 84, and access component 86.

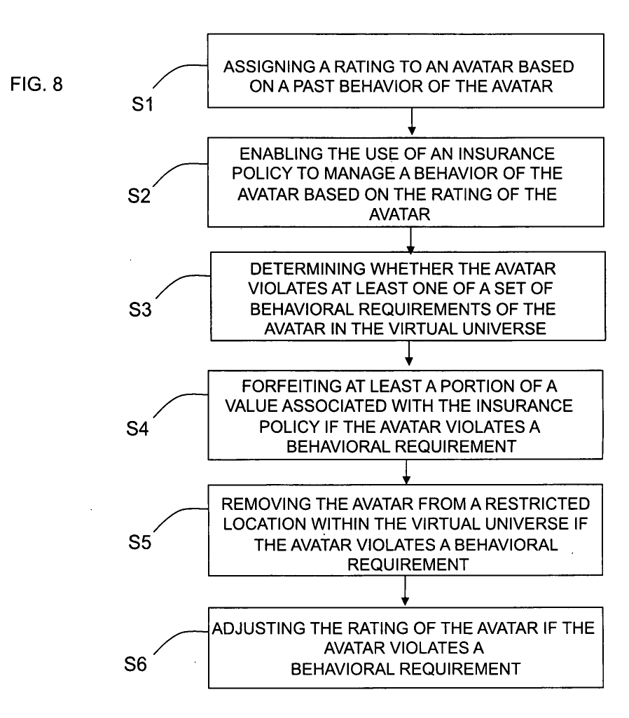

The one or more program modules 130 carry out the methodologies disclosed herein, as shown in FIG. 8. According to one embodiment, in step S1, a rating is assigned to an avatar based on a past behavior of the avatar. In S2, the use of an insurance policy is enabled to manage a behavior of the avatar in the virtual universe based on the rating of the avatar. In S3, it is determined whether a behavior of the avatar violates at least one of a set of behavioral requirement of the avatar in the virtual universe. In S4, at least a portion of a value associated with the insurance policy is forfeited if the avatar violates a behavioral requirement. In S5, the avatar is removed from a restricted location within the virtual universe if the avatar violates a behavioral requirement. In S6, the rating of the avatar is adjusted if the avatar violates a behavioral requirement.

The flowchart of FIG. 8 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions

Referring back to FIG. 7, a user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 7 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 7 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for managing avatar behavior in a virtual universe. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for managing avatar behavior in a virtual universe, comprising:
assigning a rating to an avatar based on a past behavior of the avatar; and
enabling the use of an insurance policy to manage a behavior of the avatar in the virtual universe based on the rating of the avatar.

2. The method according to claim 1, the insurance policy insuring against a violation of a set of behavioral requirements of the avatar in the virtual universe.

3. The method according to claim 2 further comprising:
determining whether the avatar violates at least one of the set of behavioral requirements of the avatar in the virtual universe; and
forfeiting at least a portion of a value associated with the insurance policy if the avatar violates at least one of the set of behavioral requirements of the avatar in the virtual universe.

4. The method according to claim 3 further comprising requiring the use of the insurance policy by the avatar as a prerequisite for entry into a restricted location of the virtual universe based on the rating of the avatar.

5. The method according to claim 4 further comprising removing the avatar from the restricted location if the avatar violates at least one of the set of behavioral requirements of the avatar in the virtual universe.

6. The method according to claim 2 further comprising adjusting the rating of the avatar if the avatar violates at least one of the set of behavioral requirements of the avatar in the virtual universe.

7. A computer system for managing avatar behavior in a virtual universe, comprising:
at least one processing unit;
memory operably associated with the at least one processing unit; and
an insurance management tool storable in memory and executable by the at least one processing unit, the insurance management tool comprising:
a rating component configured to assign a rating to an avatar based on a past behavior of the avatar; and
an insurance component configured to enable the use of an insurance policy to manage a behavior of the avatar in the virtual universe based on the rating of the avatar.

8. The insurance management tool according to claim 7, the insurance policy insuring against a violation of a set of behavioral requirements of the avatar in the virtual universe.

9. The insurance management tool according to claim 8, the insurance component further configured to:
determine whether the avatar violates at least one of the set of behavioral requirements of the avatar in the virtual universe; and
forfeit at least a portion of a value associated with the insurance policy if the avatar violates at least one of the set of behavioral requirements of the avatar in the virtual universe.

10. The insurance management tool according to claim 7 further comprising an access component configured to require the use of the insurance policy by the avatar as a prerequisite for access to a restricted location of the virtual universe based on the rating of the avatar.

11. The insurance management tool according to claim 10, the access component further configured to remove the avatar from the restricted location if the avatar violates at least one of the set of behavioral requirements of the avatar in the virtual universe.

12. The insurance management tool according to claim 8, the rating component further configured to adjust the rating of the avatar if the avatar violates at least one of the set of behavioral requirements of the avatar in the virtual universe.

13. A computer-readable medium storing computer instructions, which when executed, enables a computer system to manage avatar behavior in a virtual universe, the computer instructions comprising:
assigning a rating to an avatar based on a past behavior of the avatar; and
enabling the use of an insurance policy to manage a behavior of the avatar in the virtual universe based on the rating of the avatar.

14. The computer-readable medium according to claim 13, the insurance policy insuring against a violation of a set of behavioral requirements of the virtual universe.

15. The computer-readable medium according to claim 14, the computer instructions further comprising:
determining whether the avatar violates at least one of the set of behavioral requirements of the avatar in the virtual universe; and
forfeiting at least a portion of a value associated with the insurance policy if the avatar violates at least one of the set of behavioral requirements of the avatar in the virtual universe.

16. The computer-readable medium according to claim 13, the computer instructions further comprising requiring the use of the insurance policy by the avatar as a prerequisite for accessing a restricted location of the virtual universe based on the rating of the avatar.

17. The computer-readable medium according to claim 16, the computer instructions further comprising instructions for removing the avatar from the restricted location if the avatar violates at least one of the set of behavioral requirements of the avatar in the virtual universe.

18. The computer-readable medium according to claim 14, the computer instructions further comprising instructions for adjusting the rating of the avatar if the avatar violates at least one of the set of behavioral requirements of the avatar in the virtual universe.

19. A method for deploying an insurance management tool for use in a computer system that manages avatar behavior in a virtual universe, comprising:
providing a computer infrastructure operable to:
assign a rating to an avatar based on a past behavior of the avatar;
enable the use of an insurance policy to manage a behavior of the avatar in the virtual universe based on the rating of the avatar.

20. The method according to claim 19, the computer infrastructure further operable to establish the use of the insurance policy to insure against a violation of a set of behavioral requirements of the virtual universe, wherein the violation of the set of behavioral requirements of the virtual universe results in a forfeiture of at least a portion of a value associated with the insurance policy.
